(19) United States
(12) Patent Application Publication
(10) Pub. No.: US 2010/0151957 A1
(43) Pub. Date: Jun. 17, 2010

(54) Imaging Apparatus and Golf Diagnosis Apparatus

(75) Inventors: Kristian Hohla, Munchen (DE); Ernst Hegels, Kirchheim (DE); Georg Korn, Kleinmachnow (DE); Peter Khrustalev, Munchen (DE); Ronald Toennies, Olching (DE); Stefan Maier, Oberhaching (DE)

Correspondence Address: SMITH FROHWEIN TEMPEL GREENLEE BLAHA, LLC, Two Ravinia Drive, Suite 700, ATLANTA, GA, 30346, US

(73) Assignee: Friend for Golfers GMBH, Munchen (DE)

(21) Appl. No.: 12/161,125

(22) PCT Filed: Jan. 19, 2007
(86) PCT No.: PCT/EP2007/000479

§ 371 Date: Aug. 13, 2009

Related U.S. Application Data
(60) Provisional application No. 60/760,148, filed on Jan. 19, 2006.
(60) Provisional application No. 60/782,660, filed on Mar. 15, 2006.
(60) Provisional application No. 60/782,665, filed on Mar. 15, 2006.
(60) Provisional application No. 60/863,730, filed on Oct. 31, 2006.

(51) Int. Cl. A63B 69/36; G03B 15/03; H04N 5/225; G06F 19/00

(52) U.S. Cl. 473/221; 396/155; 348/169; 700/91; 348/E05.024

(57) ABSTRACT

An imaging apparatus comprising an illumination device adapted for illuminating a movable object during at least two timely spaced time intervals, an image sensor device adapted to capture an image of the movable object, and a control unit adapted for coordinating the illumination device and the image sensor device in a manner that the image sensor device captures the image of the illuminated movable object during the at least two timely spaced time intervals and that the image sensor device is deactivated during at least a portion of the time distance between the at least two timely spaced time intervals.

This application claims the benefit of the filing date of U.S. Provisional Patent Application No. 60/760,148 filed Jan. 19, 2006, of U.S. Provisional Patent Application No. 60/782,660 filed Mar. 15, 2006, of U.S. Provisional Patent Application No. 60/782,665 filed Mar. 15, 2006, and of U.S. Provisional Patent Application No. 60/863,730 filed Oct. 31, 2006, the disclosure of which is hereby incorporated herein by reference.

The invention relates to an imaging apparatus.

Moreover, the invention relates to a golf diagnosis apparatus.

The invention further relates to a method of imaging a moving object.

Moreover, the invention relates to a program element.

Further, the invention relates to a computer-readable medium.

U.S. 2005/0026710 A1 discloses a video image acquisition apparatus having one or multiple digital cameras taking images of a flying golf ball created by at least two flashes or strobes of light on continuous video mode at a predetermined frame rate. Each image frame is then subtracted from the background and compared to determine the existence of the ball image in flight. Furthermore, another video image acquisition apparatus is also disclosed in U.S. 2005/0026710 A1 that consists of at least two video cameras taking images of flying golf balls created by at least two flashes or strobes of light at predetermined time intervals. The apparatus then applies triangulate calculation of the two camera images to determine the exact physical locations of the flying golf balls in space at a given time of flight.

However, conventional golf diagnosis systems suffer from the fact that they are inappropriate for use in a very bright environment, for instance on a sunny day on a golf course.

It is an object of the invention to provide an accurate imaging system.

In order to achieve the object defined above, an imaging apparatus, a golf diagnosis apparatus, a method of imaging a moving object, a program element and a computer readable medium according to the independent claims are provided.

According to an exemplary embodiment of the invention, an imaging apparatus is provided comprising an illumination device adapted for illuminating a movable object at least during at least a part of at least two timely spaced time intervals, an image sensor device adapted to capture an image of the movable object, and a control unit adapted for coordinating the illumination device and the image sensor device in a manner that the image sensor device captures the image of the movable object during the at least two timely spaced time intervals and that the image sensor device is deactivated during the time distance (particularly during essentially the entire time distance) between the at least two timely spaced time intervals.

According to another exemplary embodiment of the invention, a golf diagnosis apparatus for evaluating a performance, particularly a stroke, of a golf player is provided, the golf diagnosis apparatus comprising an imaging apparatus having the above mentioned features and being adapted to capture an image of at least one of the group consisting of a golf ball and a golf club as the movable object.

According to another exemplary embodiment of the invention, a method of imaging a moving object is provided, the method comprising illuminating the moving object at least during at least a part of at least two timely spaced time intervals, capturing an image of the movable object, and coordinating the illumination and the capturing in a manner that the image of the moving object is captured during the at least two timely spaced time intervals and that the capturing is deactivated during the time distance (particularly during essentially the entire time distance) between the at least two timely spaced time intervals.

According to still another exemplary embodiment of the invention, a program element is provided, which, when being executed by a processor, is adapted to control or carry out a method of imaging a moving object having the above mentioned features.

According to yet another exemplary embodiment of the invention, a computer-readable medium is provided, in which a computer program is stored which, when being executed by a processor, is adapted to control or carry out a method of imaging a moving object having the above mentioned features.

The electronic image acquisition scheme according to embodiments of the invention can be realized by a computer program, that is by software, or by using one or more special electronic optimization circuits, that is in hardware, or in hybrid form, that is by means of software components and hardware components.

In the context of this application, the term “movable object” may particularly denote a physical structure which is adapted, designed or configured to be operated in a fluidic (particularly a gas, but possibly also a liquid) environment in which it shall move, for instance fly. Examples for movable objects are sports devices like (golf) balls or frisbees, or any kind of vehicles like aircraft.

The term “two timely spaced time intervals” may particularly denote that one or more camera units or the like detect—for instance twice—images during a certain length in time. Between these two active intervals of the one or more camera units, the one or more camera units are inactive so that no images are detected during such an idle period. Corresponding flash units may emit light pulses at least during at least a part of the active times of the cameras, or may emit a longer continuous flash during which the camera is activated multiple times, for instance twice.

The term “the image sensor device is deactivated” may particularly denote that photons impinging on the image sensor to cause detection signals are disregarded, or are not counted. This may be obtained electronically, for instance by counting photons only before and after the period of deactivation, combined with a re-initialization or re-set of the image sensor after having read out signals captured during an activation period. Alternatively, this may be obtained mechanically, for instance by placing a (movable) photon absorbing member in front of the image sensor during the period of deactivation.

The term “performance” of a golf player may particularly denote any action a golf player takes before, during or after carrying out a stroke. This may particularly include the behavior directly before the stroke, for instance when the golf player stands in front of the tee and concentrates before carrying out the stroke. It may particularly include the behavior during the stroke, for instance when the golf player swings the golf club and hits the golf ball. It may particularly include the behavior after the stroke, for instance when the golf ball has left the tee/golf club and flies in the direction of the goal.

The term “stroke” may particularly denote the entire procedure or a part of the procedure including a swing with the golf club, a hit between golf club and golf ball, and the flight of the golf ball until the ball rests. A stroke may be at least a part of the performance.

The term “stroke distance” may particularly denote the distance between a resting position of the golf ball before a stroke and after the stroke.

The term “hit” may particularly denote the short time interval in which an interaction between the golf club and the golf ball occurs.
The term “electromagnetic radiation” may particularly light, but other wavelengths (for instance infrared and/or UV light) are possible as well.

The term “golf diagnosis apparatus” may particularly denote an apparatus which may monitor the performance of a golf player and may carry out calculations in correspondence with this performance. Also golf simulators may be covered by the term “golf diagnosis apparatus”. For instance, such a golf diagnosis apparatus may comprise one or more cameras making one or more pictures of a golf ball and/or a golf club and/or a golf player in order to derive therefrom information allowing to perform a diagnosis of a golf stroke.

For instance, a stroboscope may define different points of time at which an image is taken, and the individual images may be evaluated using image recognition methods so as to analyze a stroke of a golf player. For instance, such a golf diagnosis apparatus may calculate parameters like velocity, angle, acceleration, spin, stroke distance, etc. in accordance with a stroke. Such a system may be implemented also in combination with a self-adaptive golf analysis feature, allowing to determine which body positions, or other stroke parameters statistically yield good results, and which not. Thus, such a golf diagnosis system may provide a golfer with suggestions as to how to improve the performance or provide information which parameters have been successful in the past.

In the context of such a golf diagnosis apparatus, a golfer may position a golf ball on the tee, may select a golf club and may carry out a stroke. In the vicinity of the tee (for instance at a distance of 40 cm from the golf diagnosis apparatus), the user (for instance positioned at a distance of 120 cm from the golf diagnosis apparatus) may position the golf diagnosis apparatus which may comprise a camera or another image acquisition device so that one or more images can be captured before, during and/or after hitting the ball. Such images may then be evaluated, with respect to ball, golf club, and/or body position of the golfer so as to derive parameters allowing to perform a diagnosis of a stroke so as to evaluate the quality of the stroke.

According to an exemplary embodiment, a system is provided for capturing an image of a moving object, for instance of a flying golf ball, at a plurality of times. These multiple images may be combined to form a single image showing the movable object (for instance the golf ball) multiple times during the motion so that the kinematics of the movable object can be investigated. Conventionally, it is possible to generate a plurality of flashes (like in the case of a conventional stroboscope) illuminating the object with regard to a background a plurality of times, and when the environment is sufficiently dark, the object can be seen or recognized on the image at plurality of positions. However, under some circumstances, for example when a movable object shall be detected on a sunny day, it may happen that the background is so bright that it is difficult or not possible, particularly for an image processing routine, to detect the moving object at a plurality of positions on the image. In the light of this recognition, embodiments of the invention deactivate an image sensor device (for instance a CCD camera or a CMOS camera) between the subsequent flashes or subsequent acquisition intervals, thereby suppressing image contributions of the background and consequently allowing to reliably identify the moving object a plurality of times on one image even under bright background conditions. In other words, an improvement of a stroboscopic contrast may be made possible according to an exemplary embodiment of the invention. Captured images may be evaluated regarding a position of a golf ball and/or patterns provided on the golf ball. Bright structures (like legs of a golf player, etc.) would disturb a pattern recognition procedure and may be suppressed efficiently by exemplary embodiments of the invention.

According to an exemplary embodiment, a golf launch monitor is provided in which at least two initial states of a starting golf ball may be captured using stroboscopic photography. In order to guarantee a proper contrast ratio also under bright surrounding conditions, the exposure of the image is selectively disabled apart from times during which the flashes are enlightened.

According to an exemplary embodiment, a launch monitor may measure the motion of a hit golf ball and/or the motion of the golf club before and/or after the point of time of the hit using stroboscopically acquired images. These images may subsequently be processed by a processor. For instance, the positions of markers and/or structures and/or objects (like a golf ball, a club head, a club shaft) may be determined. For this purpose, a computer or a microprocessor may be employed. For the automatic evaluation or analysis of the image, a proper contrast ratio between the desired object and the background is desirable. For this purpose, the objects in the foreground may be brightened or illuminated by flashes. Due to the quadratic decrease of the light intensity with the distance (“1/r² law”), remote objects, for instance the legs of a golfer, are illuminated significantly less than close objects, like the golf ball. Under bright surrounding conditions, for instance direct sun illumination, the objects in the background would still be significantly illuminated during the times before, after and between the flashes. However, this reduces the contrast of the desired close object of interest with regard to the background. According to an exemplary embodiment of the invention, the illumination or exposure of the image apart from the times of the flashes is prevented by deactivating the camera during specific time intervals, thereby improving the contrast and the accuracy during a subsequent image processing routine. A sufficiently fast electronic or mechanical shutter may be implemented in order to guarantee such a function.

There are different exemplary possibilities for the acquisition:
a trigger signal may actuate an image acquisition with a short exposure time.
an acquisition may be actuated with a longer exposure time and optionally with a flash. A trigger signal then actuates one or a plurality of subsequent short flashes within this exposure time.

Thus, according to an exemplary embodiment, timely precisely controlled additional acquisitions may be carried out.

The launch monitor may measure the motion of the hit golf ball and/or the motion of the golf club before and/or after the point of time of the hit. The launch monitor may be provided with optional additional devices like sensors, additional cameras or additional flashes for detecting of parameters of the motion of the golfer, the ball and/or the equipment. The communication with the additional devices can be carried out using cables or a wireless communication path. Particularly, it is possible to use Bluetooth for such a communication. It is also possible to use infrared communication, radio frequency communication, a (mobile) telecommunication network, wireless LAN (WLAN), etc.

In the following, further exemplary embodiments of the golf diagnosis apparatus will be explained. However, these embodiments also apply for the golf diagnosis apparatus, for the method of operating a golf diagnosis apparatus, for the program element and for the computer readable medium.
The golf diagnosis apparatus may comprise at least one of the group consisting of a power supply unit for supplying at least a part of the golf diagnosis apparatus with electrical energy, an optical display unit for displaying golf diagnosis related information, a user interface unit for allowing a user to communicate with at least a part of the golf diagnosis apparatus, a sensor unit for sensing at least one golf diagnosis related sensor parameter, a stroboscope unit for generating pulses of electromagnetic radiation (for instance infrared or visible or ultraviolet light flashes), and a data evaluation unit for evaluating golf diagnosis related data.
The image acquisition device may be a camera, for instance a CCD camera or a CMOS camera. It is also possible to provide a plurality of cameras.
The power supply unit may be a battery, an accumulator, solar cells, etc.
The optical display unit may be a monitor, like an LCD monitor, a TFT monitor, an OLED (organic LED) based display, a plasma monitor or a conventional cathode ray tube.
The user interface unit may comprise input elements like a keypad, a joystick, a trackball, or may even comprise a voice recognition system. The user interface unit may also include a touch screen.
A sensor unit may be any kind of sensor, like a sensor of acoustic waves (for instance for detecting a point of time at which the golf club hits the golf ball), an optical sensor, a position sensor, a pressure sensor for detecting the weight distribution within the shoes of the golfer, a pressure sensitive platform or mat (pad), etc.
One or more flashlight units, for instance strobes, may be provided so as to define different points of time at which the golf ball shall be visible at an image of the camera. Therefore, by taking a plurality of images of the golf ball and/or the golf club and/or the golf player, it is possible to derive motion parameters from the captured images.
The data evaluation unit may be a CPU (central processing unit) and may include also a storage device, an input/output unit, etc. Such a data evaluation unit may carry out calculations in accordance with pre-stored algorithms so as to derive golf analysis related parameters from the captured information.

The golf diagnosis apparatus may comprise a plurality of image acquisition devices positioned to capture images of a golf player carrying out a stroke from different viewing directions. Thus, the amount of information provided and usable for assessing a stroke and the quality thereof may be increased and refined. Particularly, complementary information from different viewing directions may be obtained.
According to an exemplary embodiment, the image sensor device may be adapted to add the images of the movable object captured during the at least two timely spaced time intervals to thereby form a single image illustrating the movable object during the at least two timely spaced time intervals. Thus, after having generated the first image of the movable object during the first illumination interval, this partial image may be stored (which may be possible by implementing a fast read-out procedure). Then, the image sensor device may remain in a deactivated state until the next flash occurs. Subsequently, the light sensitive portion of the image sensor device may be re-initialized, that is to say all information may be erased from the image sensor device. Then, when the next flash occurs, a second image is acquired which may be read out/copied in a fast manner and may be added to the previously stored picture. This procedure can be repeated, optionally, one or a plurality of times. Finally, the added image may be obtained which shows the object of interest in an illuminated state with a proper contrast to the background. This summed image may then be read out to a storage device for further analysis by an image acquisition software.
The imaging device may comprise a shutter mechanism controlled by the control unit and adapted to deactivate the image sensor device during the time distance between the at least two timely spaced time intervals. Such a shutter mechanism (for instance a mechanical shutter mechanism or an electronic shutter mechanism) may ensure that an illumination and detection of the illuminated photons occurs only at specific points of time, to thereby improve the contrast ratio. For example, an electronic configuration of such a shutter may allow to make a sensitive surface of the image sensor device only active during specific portions of time when the flashes are enlightened. By erasing information stored in such a sensor portion between subsequent flashes and by reading out the individual data after each illumination pulse, such an electronic shutter mechanism may be realized. A mechanical shutter mechanism may mechanically prevent illumination of the sensitive surface between subsequent flashes by mechanical measures, for instance with a shutter blade.
The illumination device may comprise one or more strobes. Particularly, two strobes may be arranged (particularly symmetrically with respect to the camera) and may illuminate the object under investigation simultaneously, since this may eliminate image acquisition errors resulting from geometrical asymmetry between golf ball and a single strobe. Furthermore, it is also possible to have more than two strobes, for instance three or four strobes, or more.
The illumination device may be adapted for illuminating the movable object by generating pulses of electromagnetic radiation at least during at least a part of at least a part of the at least two timely spaced time intervals. Such pulses may have essentially the shape of a Dirac pulse (a function that has the value of essentially infinity for a certain point of time, the value zero elsewhere, wherein the integral from minus infinity to plus infinity is 1), that is to say may be very intense and short in time. The pulses may have the shape of a rectangle, a saw tooth, etc.
The at least two timely spaced time intervals defining active camera times (which may be, at least partially, simultaneous/in accordance with flash times) may have a duration in a range between essentially 1 μs and essentially 200 μs, particularly in a range between essentially 10 μs and essentially (30 μs or) 40 μs. These time intervals may be particularly appropriate for golf ball shaped and colored objects which are arranged approximately 40 cm away from the detector.
Different flashes may be programmed so that the flash times are different. For example, the power of the individual flashes may differ, and their individual flash times may be adjusted so that the flash energies are essentially identical.
The time distance between the at least two timely spaced time intervals may have a duration in a range between essentially 100 μs and essentially 1 s, particularly in a range between essentially 0.5 ms (for instance for observing a golf club) and essentially 10 ms (for instance for observing a slow golf ball). Again, such time distances may be particularly dependent on typical velocities of the moving object. Thus, a re-scaling of the value of the time distance may be performed in accordance with a specific moving object, like a golf ball, a golf club, a Frisbee, etc. For instance, a typical velocity of a golf ball may be between 10 m/s and 80 m/s.
The image sensor device may capture the image of the illuminated movable object during an activation duration in a range between essentially 2 μs and essentially 400 μs, particularly in a range between essentially 20 μs and essentially 40 μs. The illumination time of an illumination sensor device, like a camera (particularly a CCD camera or a CMOS camera) may be limited by hardware restrictions. The image acquisition times may be identical to the flash times, or may differ from the flash times.
The imaging apparatus may comprise a detection unit adapted for detecting a hit of the movable object which hit sets the movable object in motion. The detection unit may be further adapted for triggering the illumination device to illuminate the object in response to the detected hit. Such a detection unit may be, for instance, a microphone which detects acoustic waves generated when a golf club hits a golf ball. Considering the propagation time of the acoustic waves (taking into account the distance between golf ball and microphone as well as the speed of sound) may be used to calculate the point of time of the hit. In accordance with this, trigger signals may be generated which trigger the generation of the first light pulse, and/or may trigger the first detection phase of the camera. This may allow to reliably detect golf ball positions providing meaningful information with regard to the kinematics and the quality of the stroke.
The imaging apparatus may comprise an evaluation unit adapted for evaluating motion characteristics of the moving object based on an analysis of the image captured by the image capture device. Such motion characteristics may include a velocity, an acceleration, a spin, angular information or a stroke width of the golf ball. For this purpose, image processing routines may be applied to the image showing a plurality of positions of the flying golf ball.
Particularly, the evaluation unit may be adapted for evaluating the motion characteristics of a ball as the moving object based on an image processing algorithm recognizing at least one of the group consisting of a bright center of the ball, a dark edge of the ball, and a shoulder between an edge of the ball and a background. When the golf ball with a spherical shape is illuminated, a center is very bright and an edge of the golf ball is quite dark. Depending on the brightness of the background, the edge of the ball may be even darker than the background or may, in another scenario, be brighter than the background. However, a shoulder between the edge and the background may be detected by the golf software due to the contrast which is improved according to exemplary embodiments of the invention.
According to a preferred embodiment of the invention, the image sensor device may comprise an illuminatable portion (light-exposed memory) and a non-illuminatable portion (light-shielded memory). The illuminatable portion may also be denoted as a bright memory (“Hellspeicher”, image array), and the non-illuminated portion may be denoted as a dark memory (“Dunkelspeicher”, storage array). The illuminatable portion may be adapted to capture individual images of the movable object under illumination by electromagnetic radiation of the movable object during the at least two timely spaced time intervals, may be adapted to supply (or copy) the individual images to the non-illuminatable portion, and may be adapted to be re-initialized between subsequent illuminations during the at least two timely spaced time intervals. Thus, the illuminatable portion may be illuminated to capture an image of the golf ball at one specific of the illumination intervals. This information may then be read out to the non-illuminatable portion in a fast manner, for instance in the order of magnitude of microseconds. Before the next detection phase, the illuminatable portion may be re-initialized, that is to say the already stored information with regard to the first interval may be erased. Then, a new detection may be initiated, a next image of the golf ball at another position may be detected, and may be supplied to the non-illuminatable portion. The non-illuminatable portion may be adapted to add the individual images supplied by the illuminatable portion to generate an added image and may be adapted to supply the added image to a storage device. In other words, the signals according to the individual positions of the golf ball may simply be summed up by the non-illuminatable portion, and the results image may then be transferred (also in a slow manner with a time constant in the order of magnitude of milliseconds) to the storage device, for instance a harddisk of a computer, for further analysis.
According to one embodiment, the illumination device may be adapted for not illuminating the movable object during at least a part of the time distance between the at least two timely spaced time intervals. In other words, the flashes may be deactivated during at least a part of a deactivation period of the camera.
According to another embodiment, the illumination device may be adapted for continuously illuminating the movable object during at least a part of the at least two timely spaced time intervals and between the at least two timely spaced time intervals. In other words, a relatively long lasting or continuous flash may be maintained activated during at least a part of a deactivation period of the camera.

The aspects defined above and further aspects of the invention are apparent from the examples of embodiment to be described hereinafter and are explained with reference to these examples of embodiment.

The invention will be described in more detail hereinafter with reference to examples of embodiment but to which the invention is not limited.

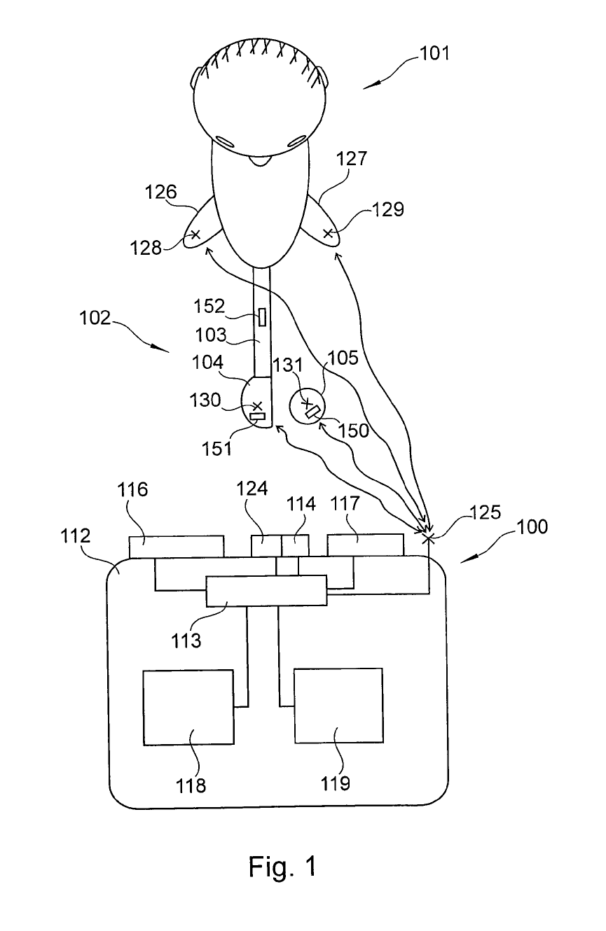

FIG. 1 illustrates a golf diagnosis system according to an exemplary embodiment of the invention.

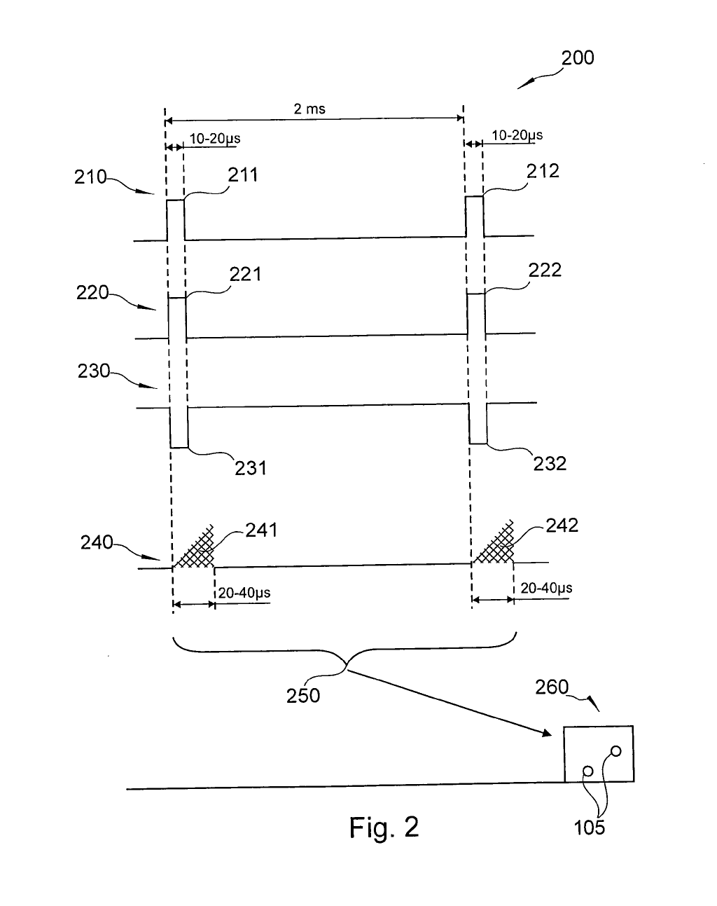

FIG. 2 illustrates a timing of individual components of a golf diagnosis apparatus according to an exemplary embodiment of the invention.

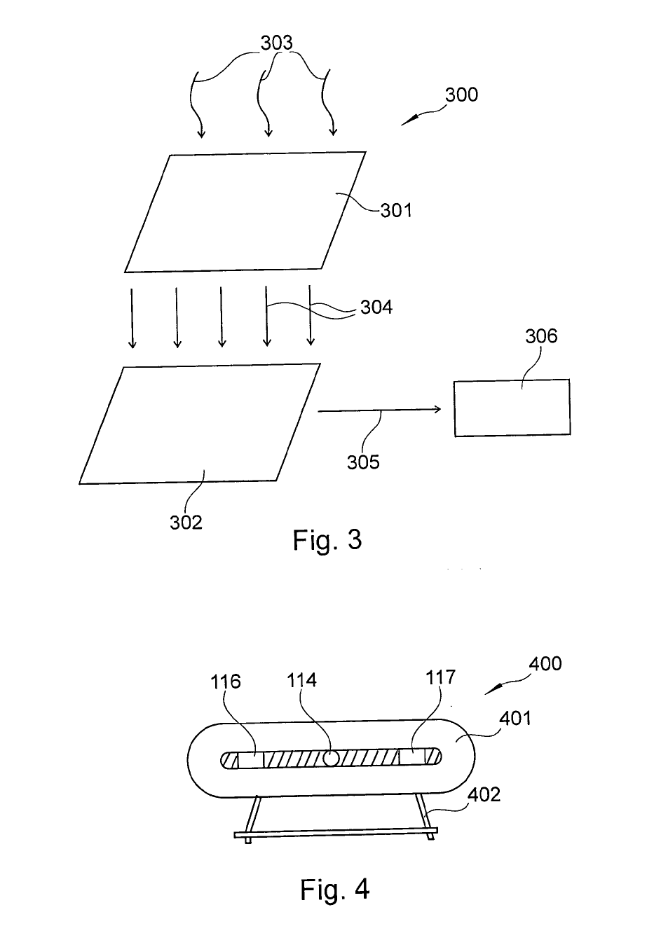

FIG. 3 illustrates a signal processing scheme of a golf diagnosis apparatus according to an exemplary embodiment of the invention.

FIG. 4 illustrates a golf diagnosis system according to an exemplary embodiment of the invention.

FIG. 5 is an image of a golf ball acquired by a conventional golf diagnosis apparatus at two points of time.

FIG. 6 is an image of a golf ball acquired by a golf diagnosis apparatus according to an exemplary embodiment of the invention at two points of time.

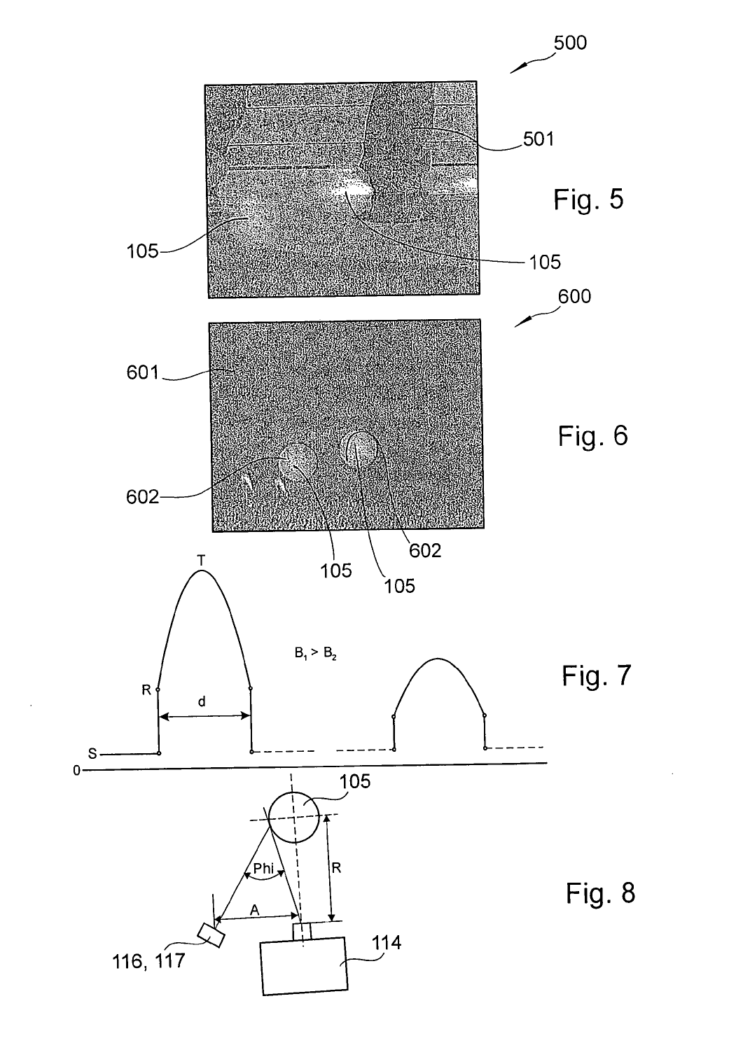

FIG. 7 and FIG. 8 illustrate principles of an image processing scheme for object recognition performed by a golf diagnosis apparatus according to an exemplary embodiment of the invention.

The illustration in the drawing is schematically. In different drawings, similar or identical elements are provided with the same reference signs.

In the following, referring to FIG. 1, a golf analysis system 100 according to an exemplary embodiment of the invention will be described.

As shown in FIG. 1, a golf player 101 is in a position to carry a golf club 102 including a shaft 103 and a club head 104. A golf ball 105 is positioned on a tee (not shown).

The golf diagnosis apparatus 100 comprises a central processing unit (CPU) 113 (which may, in another embodiment, be a microprocessor) which includes processing resources and storage resources. The CPU 113 may serve as a control system for the entire golf diagnosis apparatus 100. The CPU 113 is electrically coupled (in a bidirectional manner or in a unidirectional manner) with a CCD (charge coupled device) camera 114. Instead of providing a single CCD camera 114, it is also possible to provide two or more cameras. It may be particularly advantageous to provide only a single camera, since this may allow to manufacture the device 100 with low costs and in a small size. When a plurality of CCD cameras 114 are provided, the device 100 may be adapted to monitor the golf player 101 from different viewing directions/viewing angles so as to derive complementary information for evaluating a stroke of the golfer 101.

Furthermore, a first flash 116 and a second flash 117 are provided. The flashes 116, 117 can be positioned at any desired position of the golf diagnosis apparatus 100, particularly attached to a casing of the golf diagnosis apparatus 100. The flashes 116, 117 may emit light flashes so as to define points of time at which images of the golf club 102, of the golf ball 105 and/or of the golf player 101 are captured by the camera 114. As an alternative for the flashes 116, 117, strobes may be provided. It is possible to implement such light flash sources using LEDs, particularly OLEDs. Instead of using two flashes 116, 117, it is possible to use only one flash or at least three flashes. For example, each of the flashes 116, 117 can emit a single flash, or a single flash 116 or 117 may emit two or more flashes. Also the number of light pulses may vary, and can be larger or equal than two.

Furthermore, the CPU 113 is coupled to an LCD display 118 as an optical display unit for displaying results of the golf diagnosis.

Moreover, the CPU 113 is coupled to an input/output device 119 like a keypad, a joystick, a touch screen or the like so as to provide the CPU 113 with control information. For instance, the golfer 101 may input, via the input/output device 119, information indicating a club 102 which shall be used for the strike, so as to provide the system 100 with the required information needed to evaluate the stroke.

As further shown in FIG. 1, a microphone 124 is provided for detecting acoustic waves resulting from a hit between the golf club head 104 and the ball 105.

Furthermore, a Bluetooth communication interface 125 is provided at the golf diagnosis apparatus 100, and is coupled to the CPU 113. Via the Bluetooth communication interface 125, communication with optional sensors 128, 129 located in both shoes 126, 127 of the golfer 101 is possible. Furthermore, wireless communication with the sensor 130 provided in the golf club head 104 and with the sensor 131 provided in the golf ball 105 is possible.

Furthermore, the golf ball 105 comprises a marker 150, which may be a text or a symbol having optical properties differing from those of the surrounding of the generally white golf ball 105. In a similar manner, a marker 151 may be provided at the golf club 104, and a marker 152 may be provided at the shaft 103 of the club 102.

In the following, the functionality of the system 100 will be explained in more detail.

When the golf player 101 has operated the golf club 102 so that the golf head 104 hits the ball 105, acoustic waves are generated. These are detected—with a corresponding delay—by the microphone 124. Consequently, the flashes 116, 117 are triggered to emit light pulses, particularly two light pulses having a length of 20 μs and having a time distance of 2 ms. Correspondingly, points of time are defined by these flashes 116, 117 at which the camera 114 detects images of the hit ball 105, the moving club 102, and/or the moving golf player 101 (essentially) during or after the hit.

Furthermore, sensor information from the sensors 128 to 131 are transmitted to the Bluetooth communication interface 125. All these items of information may be used by the CPU 113 to derive golf diagnosis information, like angle information, velocity information, distance information, etc. A result of such an evaluation may be output via the display unit 118.

As an alternative to the microphone 124, a light barrier may be provided for detecting the time of hitting the ball 105.

More particularly, the golf diagnosis apparatus 100 comprises an imaging apparatus formed by the illumination arrangement (namely the flashes 116, 117) adapted for illuminating the moving golf ball 105 during two or more timely spaced intervals, defined by the duration of the flashes and the time distance between subsequent flashes. The CCD camera 114 (alternatively a CMOS camera) is provided to capture an image of the moving golf ball 105. The CPU 113 serves as a control unit for coordinating the flashes 116, 117 and the CCD camera 114 in a manner that the CCD camera 114 captures the image of the illuminated golf ball 105 during the two or more timely spaced time intervals and that the CCD camera 114 is deactivated during at least a portion of the time distance between the at least two timely spaced time intervals. In other words, the camera 114 will be activated only during specific points of time which correlate at least partially with the illuminating times of the flashes 116, 117. This will be explained in more detail below referring to FIG. 2 and FIG. 3.

However, the CCD camera 114 adds the images of the flying golf ball 105 captured during the multiple flashes of the flash units 116, 117 to thereby form a single image illustrating the flying golf ball 105 during the flash intervals. However, a shutter mechanism, more particularly an electronic shutter mechanism, of the CCD camera 114 deactivates, under the control of the CPU 113, the CCD camera 114 during the major part of the time distance between the light pulses emitted by the flashes 116, 117. According to the described embodiment, the flashes 116, 117 emit the light pulses simultaneously. Alternatively, the different flashes 116, 117 may be used to generate flashes at different points of time.

The CPU 113 also serves as an evaluation unit for evaluating motion characteristics of the flying golf ball 105 based on an analysis of the image captured by the CCD camera 114. On this image, the golf ball 105 is displayed in an illuminated fashion at different times during the golf ball 105 flight. Since the flashes 116, 117 are positioned so that the CCD camera 114 is located between the flashes 116, 117, the camera 114 is positioned essentially symmetrically and detects a bright centre of the ball 105 surrounded by a dark circular edge of the ball 105. An image processing software running on the CPU 113 recognizes particularly a shoulder between the edge of the ball 105 and a (grey) background. Due to the deactivation of the camera 114 between the flashes generated by the flash units 116, 117, the contrast between the bright ball and the dark background is improved or enhanced, thereby allowing the image processing routines to be performed with improved accuracy, providing more meaningful golf diagnosis results.

In the following, referring to FIG. 2, a timing scheme 200 illustrating a timing of the individual components of the golf diagnosis apparatus 100 will be explained.

A signal 210 indicates a trigger signal for triggering the flash units 116, 117. A signal 220 indicates the duration of the flashes generated by the flash units 116, 117. A signal 230 illustrates the time dependence of a trigger signal of the camera 114 shutter. Time intervals during which the camera 114 is actually illuminated are plotted along a time axis 240.

The horizontal directions of the schemes 210, 220, 230, 240 denote the time, and the vertical direction the amplitude or logical value of the signals.

When a golf ball 105 is hit, this may be recognized by a microphone 124. This signal may be conveyed from the microphone 124 to a CPU or microcontroller unit 113, which generates the trigger signals 211 and 212 for triggering the flashes 116, 117. In other words, during the time intervals 211, 212, the flashes emit flash pulses 221 and 222, respectively. In accordance with these flashes 221, 222, the camera 113 shutter is operated, and generated camera 113 control signals during time intervals 231 and 232, respectively.

Accordingly, the CCD camera 113 is illuminated during time intervals 241 and 242, respectively. This is illustrated schematically as triangles in FIG. 2, since photons are integrated or accumulated during these active times 241, 242 of the CCD camera 114.

The individual signals of the camera 113 captured during the time intervals 241 and 242 are added which is schematically described by a bracket 250. The result of this is an image 260 showing the golf ball 105 at two different positions during a flight—in front of a dark background obtained due to the camera deactivation.

FIG. 3 indicates a scheme 300 of data processing within the CCD camera 114.

The CCD camera 114 implemented in the embodiment of FIG. 1 comprising an illuminatable portion (“Hellspeicher”) 301 and a non-illuminatable portion 302 (“Dunkelspeicher”).

The illuminatable portion 301 is light-sensitive and is adapted to capture individual images of the movable golf ball 105 under an illumination by light 303 during the at least two timely spaced time intervals 241, 242. The illuminatable portion 301 is further adapted to supply or copy the individual images to the non-illuminatable portion 302. Furthermore, the illuminatable portion 301 may be re-initialized between subsequent illuminations during the at least two timely spaced time intervals 241, 242.

The non-illuminatable portion 302 is adapted to add the individual images 304 supplied by the illuminatable portion 301 to generate an added image 305 to be supplied to a storage device 306 of an analysis computer (not shown) or of the CPU 113 by which the added image 305 may be further processed.

After the illuminated portion 301 has detected the light signals from the flying golf ball during the time interval 241, this image data is copied into the non-illuminated portion 302. This may be a very fast procedure, in the order of magnitude of μs. After the time interval separating the intervals 241 and 242, the illuminatable portion 301 may be re-initialized and becomes activated again and captures the image of the golf ball 105 at a later interval of time, that is to say during the interval 242. Again, the data related to the second image are copied as data 304 into the non-illuminated portion 302. By taking this measure, the data of the first image and the second image are simply added in the non-illuminated portion 302, in a fast manner in the order of magnitude of μs. Only after having captured the last image (that is to say after the interval 242), the entire image data is transferred as data 305 to the storage device 306, which may be slow, for instance in the order of magnitude of ms. After that, the data is stored on the harddisk 306 for further analysis.

The advantage of the electronic shutter mechanism of FIG. 3 is that the slow read-out procedure between the units 302 and 306 occurs only once.

FIG. 4 shows a golf diagnosis apparatus 400 according to an exemplary embodiment of the invention having implemented the image acquisition device described referring to FIG. 2 and FIG. 3.

The golf acquisition device 400 shown in FIG. 4 comprises a housing 401. The housing 401 is installed on a mount 402. A single CCD camera 114 is shown as well as the symmetrically mounted flashes 116, 117.

FIG. 5 illustrates an image 500 acquired by a conventional golf diagnosis apparatus under bright conditions.

In the image 500, the golf ball 105 is visible only with a poor quality at two different points of time. In the background, legs 501 of a golf player are shown. Due to the poor contrast between the golf ball 105 and the background, particularly the legs 501, an automated image processing routine will have significant problems to detect the positions of the poorly resolved golf balls 105 to determine its motion characteristics.

The embodiment of FIG. 5 relates to a CCD camera which is not deactivated between subsequent flashes. The image 500 has been captured with a continuous shutter opening time of 2.2 ms.

In contrast to this, FIG. 6 shows an image 600 captured by the imaging apparatus shown in FIG. 4 and having implemented the image acquisition scheme as described referring to FIG. 2 and FIG. 3.

The legs of the golf player are almost invisible and the golf ball 105 can be resolved with high accuracy at the two different points of time. This results from the deactivation of the CCD camera 113 between two subsequent flashes.

The image of FIG. 6 has been captured with two short shutter opening times of 30 μs with a time distance of 2 ms.

On the basis of the image 600, an image processing software may accurately determine the most likely positions of “two objects” with an “inner bright portion” and a “surrounding dark portion”, which have a “round shape” and a “size in a predetermined range”. Thus, pattern recognition algorithms may be used to automatically detect the golf ball 105 at the various positions. Markers 602 provided on the golf ball 105 may be evaluated to determine spin characteristics or the like. Furthermore, a transfer from two dimensions into three dimensions can be performed, so as to determine the velocity and a rotating axis of the ball 105.

In the following, referring to FIG. 7 and FIG. 8, a procedure of an edge contrast improvement by integration time adjustment according to an exemplary embodiment of the invention will be explained.

When designing a camera for a golf diagnosis apparatus, the following frame conditions may be considered:

1. A multiple exposure in a short time may enable a cost efficient stroboscopic image acquisition, since the information can be stored in one frame (image). No high speed camera, or the like, is necessary.

2. For the significant improvement of the contrast, the integration time Tᵢ shall be reduced to the flash duration without flash energy losses. A proper edge contrast may be important for the reliability and accuracy of the image processing.

Referring to FIG. 7, t is the flash duration, S is the trace brightness of the ball, R is the edge brightness of the ball, and T is the brightness in the centre of the ball.

The trace brightness S has contributions from the (damped) background brightness and brightness contributions from a smeared out ball 105. The edge brightness R depends on sin(Phi), as shown in FIG. 8.

The brightness R at the edge of the ball has contributions from the trace brightness S and the sum from the flash brightnesses, which illuminate the edge of the ball, reduced by the geometry and scattering degree.

In the following, the contrast of the ball edge and the ball center relative to the ball trace will be calculated:

In this context, K_{ST} is denoted as the contrast of the ball center relative to the ball trace:

K_{ST}=(T−S)/(T+S)=1/(C₁Tᵢ+1)

K_{SR} is denoted as the contrast of the ball edge relative to the ball trace:

K_{SR}=(R−S)/(R+S)=1/(C₂Tᵢ+1)

C₁ and C₂ are constants which describe the influence of flash brightness, background brightness, scattering degree and geometry.

The described equations show that a short time Tᵢ results in a high contrast K_{SR} and K_{ST}.

It should be noted that the term “comprising” does not exclude other elements or features and the “a” or “an” does not exclude a plurality. Also elements described in association with different embodiments may be combined.

It should also be noted that reference signs in the claims shall not be construed as limiting the scope of the claims.

1. An imaging apparatus, comprising:
an illumination device adapted for illuminating a movable object at least during at least a part of at least two timely spaced time intervals;
an image sensor device adapted to capture an image of the movable object; and
a control unit adapted for coordinating the illumination device and the image sensor device in a manner that the image sensor device captures the image of the movable object during the at least two timely spaced time intervals and that the image sensor device is deactivated during the time distance between the at least two timely spaced time intervals.

2. The imaging apparatus of claim 1, wherein the image sensor device is adapted to selectively add the images of the movable object captured during the at least two timely spaced time intervals to thereby form a single image illustrating the movable object during the at least two timely spaced time intervals.

3. The imaging apparatus of claim 1, further comprising a shutter mechanism controllable by the control unit and adapted to deactivate the image sensor device during the time distance between the at least two timely spaced time intervals.

4. The imaging apparatus of claim 3, wherein the shutter mechanism comprises at least one of the group consisting of a mechanical shutter mechanism and an electronic shutter mechanism.

5. The imaging apparatus of claim 1, wherein the illumination device comprises one or more strobes, particularly two strobes being arranged symmetrically with respect to the image sensor device.

6. The imaging apparatus of claim 1, wherein the illumination device is adapted for illuminating the movable object by generating pulses of electromagnetic radiation at least during at least a part of the at least two timely spaced time intervals.

7. The imaging apparatus of claim 1, wherein the at least two timely spaced time intervals have a duration in a range between essentially 1 μs and essentially 200 μs, particularly in a range between essentially 10 μs and essentially 40 μs, more particularly in a range between essentially 20 μs and essentially 40 μs.

8. The imaging apparatus of claim 1, wherein the time distance between the at least two timely spaced time intervals has a duration in a range between essentially 100 μs and essentially 1 s, particularly in a range between essentially 0.5 ms and essentially 10 ms.

9. The imaging apparatus of claim 1, further comprising a detection unit adapted for detecting a hit of the movable object which hit initiates a motion of the object, the detection unit being further adapted for triggering the illumination device to illuminate the object in response to the detected hit.

10. The imaging apparatus of claim 1, further comprising an evaluation unit adapted for evaluating motion characteristics of the movable object based on an analysis of the image of the movable object captured by the image capture device.

11. The imaging apparatus of claim 10, wherein the evaluation unit is adapted for evaluating the motion characteristics of a ball as the movable object based on an image processing algorithm recognizing at least one of the group consisting of a bright center of the ball, a dark edge of the ball, and a shoulder between an edge of the ball and a background.

12. The imaging apparatus of claim 1, wherein the image sensor device comprises an illuminatable portion and a non-illuminatable portion,
the illuminatable portion being adapted to capture individual images of the movable object under illumination by electromagnetic radiation of the movable object during the at least two timely spaced time intervals, being adapted to supply the individual images to the non-illuminatable portion, and being adapted to be re-initialized between subsequent illuminations during the at least two timely spaced time intervals; and
the non-illuminatable portion being adapted to add the individual images supplied by the illuminatable portion to generate an added image and being adapted to finally supply the added image to a storage device.

13. The imaging apparatus of claim 1, wherein the illumination device is adapted for not illuminating the movable object during at least a part of the time distance between the at least two timely spaced time intervals.

14. The imaging apparatus of claim 1, wherein the illumination device is adapted for continuously illuminating the movable object during at least a part of the at least two timely spaced time intervals and between the at least two timely spaced time intervals.

15. A golf diagnosis apparatus for evaluating a performance, particularly a stroke, of a golf player, the golf diagnosis apparatus comprising an imaging apparatus according to claim 1, adapted to capture an image of at least one of the group consisting of a golf ball and a golf club as the movable object.

16. The golf diagnosis apparatus according to claim 15, comprising at least one of the group consisting of a power supply unit for supplying at least a part of the golf diagnosis apparatus with electrical energy, an optical display unit for displaying golf diagnosis related information, a user interface unit for allowing a user to communicate with at least a part of the golf diagnosis apparatus, a sensor unit for sensing at least one golf diagnosis related sensor parameter, and a data evaluation unit for evaluating golf diagnosis related data.

17. A method of imaging a moving object, the method comprising
illuminating the moving object at least during at least a part of at least two timely spaced time intervals;
capturing an image of the movable object;
coordinating the illumination and the capturing in a manner that the image of the moving object is captured during the at least two timely spaced time intervals and that the capturing is deactivated during the time distance between the at least two timely spaced time intervals.

18. A program element, which, when being executed by a processor, is adapted to control or carry out a method of claim 17 of imaging a moving object.

19. A computer-readable medium, in which a computer program is stored which, when being executed by a processor, is adapted to control or carry out a method of claim 17 of imaging a moving object.
